(19) United States
(12) Patent Application Publication
(10) Pub. No.: US 2024/0270354 A1
(43) Pub. Date: Aug. 15, 2024

(54) Gyroscope for an Anti-Roll Stabilizer

(71) Applicant: Smartgyro s.r.l., La Spezia (SP) (IT)

(72) Inventor: Paolo SALUTARI, La Spezia (SP) (IT)

(21) Appl. No.: 18/289,724

(22) PCT Filed: May 6, 2022
(86) PCT No.: PCT/EP2022/062270

§ 371 Date: Nov. 6, 2023

(30) Foreign Application Priority Data
May 7, 2021 (IT) 102021000011756

(51) Int. Cl. B63B 39/04; H02K 7/02; H02K 7/08

(52) U.S. Cl. CPC B63B 39/04; H02K 7/02; H02K 7/083

(57) ABSTRACT

A gyroscope for an anti-roll stabilizer for a seacraft is provided, comprising a housing, arranged to be mounted on a suspension allowing the housing to be oscillated around a first rotation axis, a flywheel, positioned inside the housing, comprising a flywheel body connected to a shaft arranged to rotate around a second rotation axis, the shaft of the flywheel having a first and a second end, a first bearing pack rotationally connecting the first end of the shaft to the housing, a second bearing pack rotationally connecting the second end of the shaft to the housing, an electric motor comprising a rotor and a stator, wherein the stator of the electric motor is connected to the housing and the rotor of the electric motor is connected of the flywheel, and the rotor is located radially at a greater distance from the second rotation axis than the stator.

### TECHNICAL FIELD

The aspects and embodiments thereof relate to the field of anti-roll stabilizers for seacrafts, and in particular to a gyroscope for the anti-roll stabilizer.

### BACKGROUND

Anti-roll stabilizers are devices used for reducing the rolling of seacraft. Different types of anti-roll stabilizers are known. For example, hydraulic fin stabilizers are known. Such anti-roll stabilizers may comprise one or more fins outwardly extending from a hull of a vessel beneath the waterline of the seacraft. Although fin stabilizers may help to counteract rolling of a vessel, a disadvantage may lie in that such stabilizers have little effect when a seacraft is at low speed or at anchor.

Gyroscope anti-roll stabilizers form an alternative type of stabilizer that can work relatively well for seacraft, such as yachts, at low speeds or at anchor.

Gyroscope anti-roll stabilizers exploit the physical principle of the gyroscope, whereby a rotating mass offers a greater opposition to an external force which attempts to divert the initial rotation axis thereof. The gyroscope of an anti-roll stabilizer comprises a flywheel mounted on a shaft, actuated by an electric motor, in which it is supported by rolling bearings (usually ball bearings). The flywheel of such gyroscope may rotate at a relatively high rotational speed, for instance, in particular when used in yachts, at a rotational speed of for instance about 5.500 or about 10.500 rpm.

Put briefly, the gyroscope being able to oscillate, with respect to two axes, it creates an action of contrast to the oscillations whereto the seacraft is subjected and, in particular, to rolling. Anti-roll stabilizers are devices installed inside the hulls of seacraft, typically near the keel of the seacraft.

WO201922432 discloses a gyroscope for an anti-roll stabilizer for a seacraft, comprising a housing and a flywheel placed in the housing, mounted between two bearings. An electric motor with a shaft is provided for rotating the flywheel. One of the bearings is located between the flywheel and the electric motor.

### SUMMARY

It is preferred to provide for a compact anti-roll stabilizer, which hence can be used for smaller seacrafts with less volume available inside the hull. It is also preferred to be able to perform maintenance of the anti-roll stabilizer inside the hull.

A first aspect provides a gyroscope for an anti-roll stabilizer for a seacraft, comprising a housing, arranged to be mounted on a suspension which allows the housing to be oscillated around a first rotation axis, a flywheel, positioned inside the housing, comprising a flywheel body connected to a shaft arranged to rotate around a second rotation axis, substantially transverse to the first axis, the shaft of the flywheel having a first end and a second end, a first bearing pack rotationally connecting the first end of the shaft to the housing, a second bearing pack rotationally connecting the second end of the shaft to the housing, an electric motor arranged to rotate the flywheel around the second rotation axis, comprising a rotor and a stator, wherein the stator of the electric motor is connected to the housing and the rotor of the electric motor is connected of the flywheel, and the rotor is located radially at a greater distance from the second rotation axis than the stator.

By having the rotor radially at a greater distance from the second rotation axis than the stator, the rotor can be placed around the stator. As such, for example an outrunner type or external rotor type motor may be obtained, i.e. the stator forms the core of the motor and the rotor surrounds the stator. Thanks to this configuration of the motor, the motor may be arranged between the two bearing packs with the stator arranged coaxially to the flywheel shaft and releasably connected to one bearing pack, while the rotor is releasably connected to the flywheel body.

The flywheel may have a recess, disposed around its rotational axis, arranged to accommodate the electromotor. The external rotor may be mechanically connected to an internal surface of the recess, and the electromotor may have an external diameter greater that its height, making possible its insertion into the recess of the flywheel. Thanks to these features, the dimensions of the housing may be reduced to those required to accommodate the flywheel, i.e. the presence of the motor may not affect or significantly affect the external dimensions of the gyroscope.

The stator may be separated from the rotor simply by pulling the stator axially relative to the rotor. Thanks to this feature, the stator may for example be removed by removing a part of the housing, without necessarily needing to remove a bearing pack from the housing and/or the flywheel from the housing, which flywheel may be one of the most heavy and/or voluminous components of the gyroscope.

In embodiments, the motor may be a brushless motor with two pairs of poles and for example a maximum working frequency of 666 Hz (equivalent to 10,000 RPM). The brushless motors may have three phases and therefore the gyroscope may need three phases supply conductors and one grounding conductor.

As a further option, each conductor may have its own passage in the bearing pack, and four passages are distributed circumferentially, on a circle arc, around the axis of rotation. This feature may allow to make the stator winding more compact. As an even further option, even a fifth passage for three pairs of wires for the motor's thermal protection may be provided. The passages or the holes may be generally small in diameter to not affect the mechanical characteristics of the bearing unit to any great extent.

A bearing pack may comprise one or more bearings, in particular ball or needle bearings. In particular, an inner ring of a bearing may surround the shaft of the flywheel, and an outer ring of a bearing may be connected to the housing. An outer ring being connected to the housing may at least imply that in use the outer ring does not rotate relative to the housing. The bearings may be preloaded, for example to remove or reduce play between the rings and the balls. In anti-roll stabilizers, the bearings may be subjected to harsh working conditions and therefore frequent bearing replacements may be necessary.

When the electric motor is positioned between the first bearing pack and the second bearing pack, a more compact design of the gyroscope may be achieved.

At least part of the flywheel, in particular part of the flywheel body, may be located radially at a greater distance from the second rotation axis than the rotor. As such, in use, when the rotor is rotated, centrifugal forces force the rotor against the flywheel, in particular against the flywheel body. This may in turn hold the rotor in place, especially at high rotational speeds.

When the stator is located radially at a greater distance from the second rotation axis than the shaft, the stator may be positioned at least partially surrounding the shaft.

To allow the shaft to rotate relative to the stator, an annular space may be provided between the shaft of the flywheel and the stator. In general, the shaft may be a solid shaft.

The flywheel body may have a first recess disposed around the second rotation axis arranged to accommodate the stator and the rotor. As a further option, the flywheel body may have a second recess around the second rotation axis on an opposite side of the first recess. A recess may allow positioning of other components therein, and/or may allow for a lighter flywheel.

As a particular option, which as other options may be applied to any embodiment of the gyroscope, the housing may comprise an upper segment, a central segment and a lower segment which are arranged such that the upper segment can be releasably connected to an upper part of the central segment and the lower segment can be releasably connected to a lower part of the central segment. The releasable connection between segment may be an air-tight connection. Preferably, the shaft extends through the central segment of the housing, in particular from the upper segment to the lower segment of the housing. As such, a length of the shaft may generally correspond to a height of the central segment, i.e. at least correspond to 80% or at least correspond to 90% of the height of the central segment, or may even be larger than a height of the central segment.

In use, the volume inside the housing may be at a lower pressure than the ambient pressure surrounding the housing. This may decrease friction for the flywheel, but may also decrease cooling of the flywheel due to lowered conduction and convection with any gas left inside the housing. If the cooling is decreased below a preferred or required cooling rate, additional cooling means for example using a cooling fluid distribution network may be used.

The housing may further comprise a top cap releasably connected to the upper segment on an opposite side than the central segment and covering the first bearing pack, and a bottom cap releasably connected to the lower segment on an opposite side than the central segment and covering the 20 second bearing pack.

The housing may comprise an opening for a power cable of the electric motor. The opening may for example be arranged to be sealed air tight with resin when the power cable is present in the opening.

In particular, the top cap may be provided with the opening for the power cable. As a further option, the power cable may be releasably connected to the electric motor. As such, replacing the power cable does require access to the motor.

For cooling one or more components of the gyroscope, the gyroscope may further comprise a cooling fluid distribution network for circulating cooling fluid through the gyroscope, comprising a housing conduit for distributing fluid through the housing.

A fluid distribution network is to be understood as comprising or being a collection of one or more conduits, passages, hollow sections, or any other conduits for transporting a cooling fluid through, which may be in fluid communication with each other. The fluid distribution network may comprise one or more inlets, and one or more outlets. In use, fluid may be distributed or pumped through the fluid distribution network. Thermal energy may be transferred from the gyroscope to the fluid, and thus the gyroscope may be cooled.

In general, a cooling fluid may comprise liquid and/or gaseous matter, such as water, glycol, air, or any other liquid, any other gas, or any combination thereof.

A second aspect provides an anti-roll stabilizer for a vessel, comprising a gyroscope for example according to the first aspect, a frame arranged to be mounted to a vessel, in particular inside the hull of a vessel and a suspension allowing the housing of the gyroscope to be oscillated around a first rotation axis relative to the frame.

A third aspect provides a vessel, in particular a yacht, provided with the anti-roll stabilizer according to the second aspect.

A fourth aspect provides a method of servicing or maintaining a gyroscope of an anti-roll stabilizer onboard of a yacht or other vessel, comprising the steps of disconnecting an upper segment from a housing of the gyroscope for exposing a flywheel and an electric motor, at least one of disconnecting a rotor of the electric motor from the flywheel, and disconnecting a stator of the electric motor from the upper segment of the housing, at least one of reconnecting a rotor of the of the electric motor to the flywheel, and reconnecting a stator of the electric motor to the upper segment of the housing, reconnecting the upper segment to the housing of the gyroscope, and, optionally, removing air from an interior of the housing after the upper segment has been reconnected to the housing.

By being able to service or maintain the gyroscope onboard of the yacht or other vessel or seacraft, transport of the gyroscope away from the vessel or seacraft may be avoided. Instead, a new component may be transported to the vessel or seacraft, such as a new stator, rotor, bearing, or any other component, and connected to the gyroscope on board.

When the stator is disconnected from the upper segment of the housing, the method may further comprise disconnecting a bearing pack from the housing, and reconnecting a bearing pack to the housing. The bearing pack may in particular be the first bearing pack. The particular order of disconnecting may that first the upper segment is disconnected from the remainder of the housing, followed by disconnecting the stator from the first bearing pack. The first bearing pack may then be disconnected from the upper housing segment. The reconnected first bearing pack may be a new bearing pack, or the disconnected bearing pack on which maintenance has been performed.

It will be understood that options disclosed in conjunction with one aspect, for example the first aspect, may be readily combined with embodiments of other aspects.

### BRIEF DESCRIPTION OF THE FIGURES

In the figures,

FIG. 1 schematically depicts a yacht as an example of a seacraft;

FIG. 2 shows a section view of an embodiment of a gyroscope;

FIG. 3 depicts the gyroscope in a partially exploded section view;

FIG. 4A depicts part of the gyroscope in another exploded section view;

FIG. 4B depicts another part of the gyroscope in an exploded section view;

FIG. 5A depicts a further part of the gyroscope in a further exploded section view;

FIG. 5B depicts an even further part of the gyroscope in an even further exploded section view; and

FIG. 6 depicts a detailed section view of part of the gyroscope.

### DETAILED DESCRIPTION OF THE FIGURES

In general, in the figures, different components may be depicted cross-hatched, with different types of cross-hatching. For example, an angle and/or density of cross-hatching may differ between components. Where in the figures no cross-hatching is shown, this may indicate that locally no component is present. Instead, for example, air, fluid or a vacuum may be present there.

In particular inside the housing, a vacuum or low pressure environment may be present. As such, the housing may be sealed air-tightly, for example using O-rings. In particular, one or more of the three housing segments, the two bearing packs and the two caps may be sealed to maintain the low pressure inside the housing.

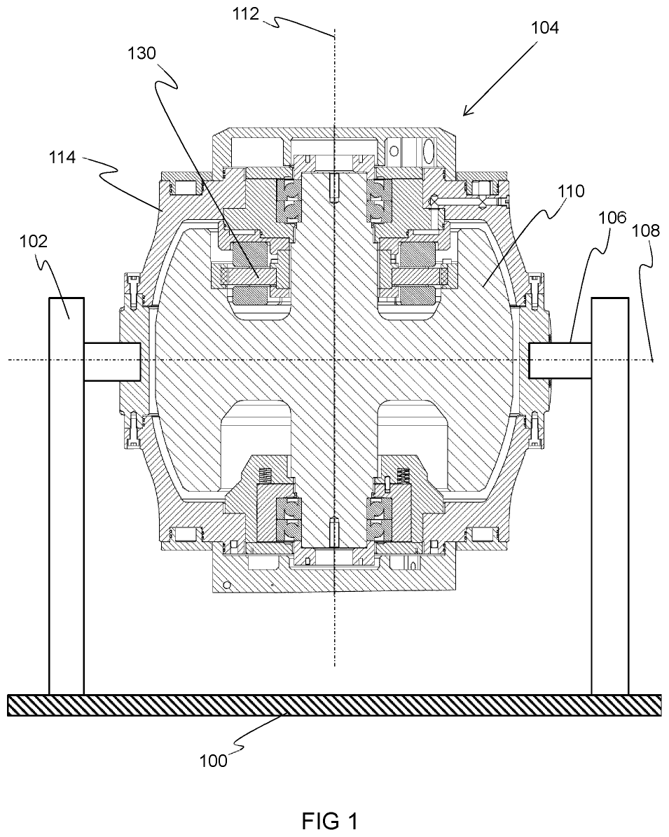

FIG. 1 schematically depicts a yacht as an example of a seacraft, of which part of a hull 100 is schematically shown. Mounted to the hull 100 is a frame 102. The seacraft is provided with an embodiment of a gyroscope 104. The gyroscope 104 is connected to the hull 100 via a suspension 106, which in turn in connected to the frame 102.

The suspension 106 allows rotation or oscillation of the gyroscope 104 around a first rotation axis 108 relative to the frame. The gyroscope 104 comprises a flywheel 110 positioned inside a housing 114, arranged to be rotated around a second rotation axis 112. The second rotation axis 112 may be perpendicular to the first rotation axis 108. For rotating the flywheel 110 around the second rotation axis 112, the gyroscope 104 comprises a motor 130, which for example is an electric motor.

As can be seen in FIG. 1, the outer footprint of the gyroscope 104 may be determined by the housing. The motor 130 is positioned such that it does not affect the outer footprint of the gyroscope 104. This in turn may contribute to obtaining a compact anti-roll stabilizer.

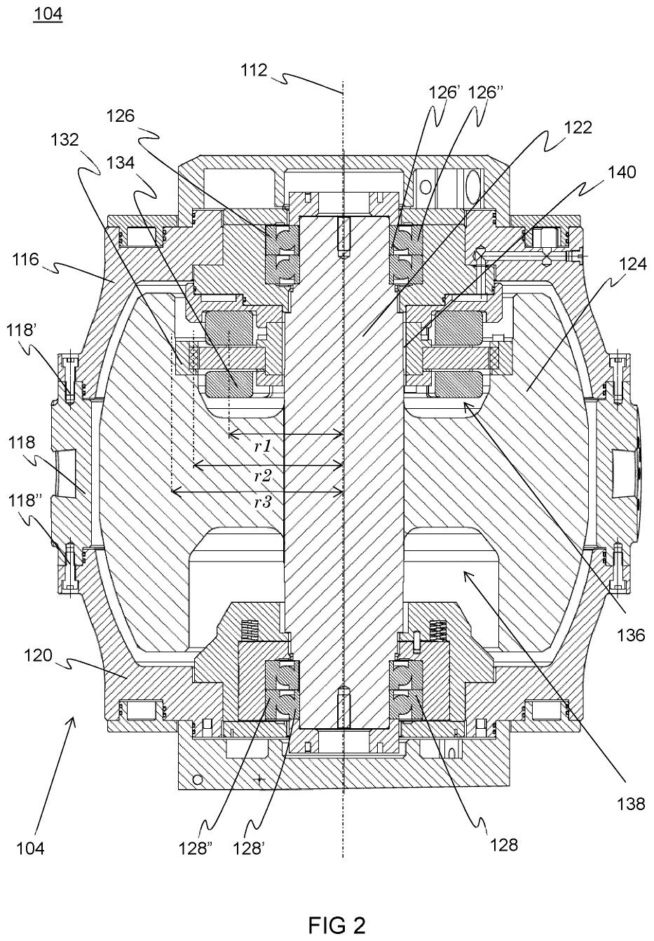

FIG. 2 shows a section view of an embodiment of a gyroscope 104. Options discussed in conjunction with this embodiment may be readily applied to other embodiments of the gyroscope, for example the embodiment shown in FIG. 1.

The housing 114 in FIG. 2 comprises an upper segment 116, a central segment 118 and a lower segment 120. The upper segment 116 is releasably connected to an upper part 118′ of the central segment 118 and the lower segment 120 is releasably connected to a lower part 118″ of the central segment 118. As an option, the housing 114 may be a generally spherical housing.

The flywheel 110 comprises a shaft 122 and a flywheel body 124. As an option, the shaft 122 and flywheel body 124 are comprised by a single integrally formed flywheel part. Alternatively, the flywheel may be formed from multiple connected parts, such as a shaft connected to a separate flywheel body, as depicted in FIG. 2. It will be understood that in general, the shaft and the flywheel body rotate together in use.

A first bearing pack 126 or upper bearing pack rotationally connects a first end of the shaft 122 to the housing, in particular to the upper segment 116. A second bearing pack 128 or lower bearing pack rotationally connects a second end of the shaft 122 to the housing, in particular to the lower segment 120. Rotationally connects here implies that the shaft can be rotated around the second rotation axis 112 relative to the housing by virtue of the bearing packs. A bearing pack may for example be press-fitted into an opening of the housing.

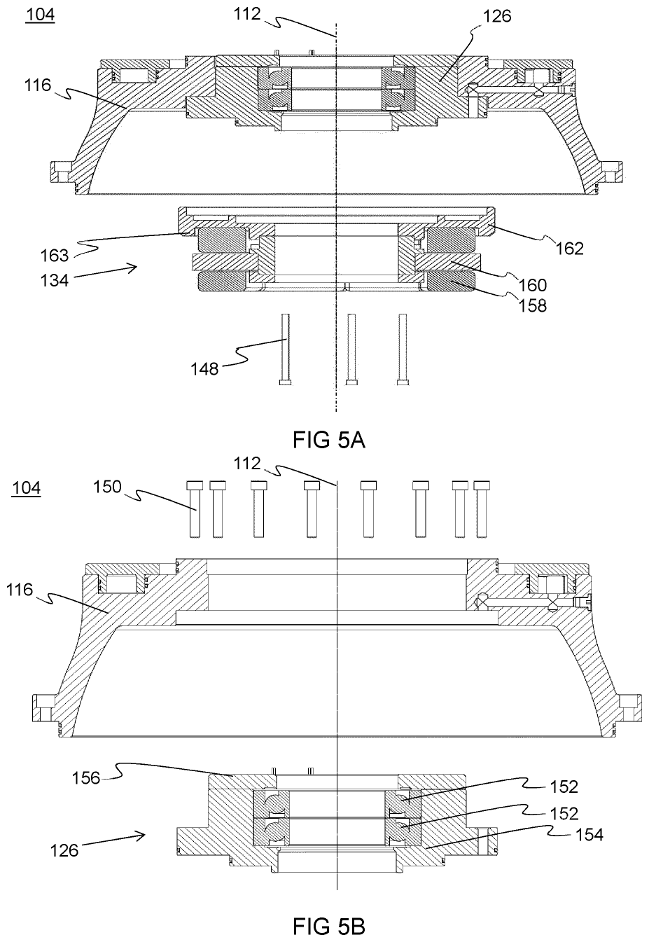

In FIG. 2, the first bearing pack 126 is shown comprising an inner ring 126′ surrounding the shaft and an outer ring 126″ connected to the housing, and the second bearing pack 128 is shown comprising an inner ring 128′ surrounding the shaft and an outer ring 128″ connected to the housing. As will be understood in conjunction with FIGS. 5A-5B, the outer ring 126″ may be connected to the housing via a bushing, such as a bearing carrier 154. Alternatively, an outer ring of a bearing pack may be directly connected to the housing.

The electric motor comprises a rotor 132 and a stator 134. In particular, by feeding an electric current through the stator 134, the rotor 132 is rotated relative to the stator 134. The rotor 132 is connected to the flywheel, in particular to the flywheel body 124. As such, when the rotor 132 is rotated, the flywheel body 124 is rotated with it.

Indicated in FIG. 2 is a first radial distance r1 between the second rotation axis of rotation 112 and the stator 134, in particular a centre of the windings of the stator 134. Also indicated is a second radial distance r2 between the second rotation axis of rotation 112 and the rotor 132, in particular a centre of the magnets of the rotor 132. The second radial distance r2 is larger than the first radial distance r1. As such, the rotor 132 and in particular the entire rotor 132 surrounds the stator 134, in particular the windings of the stator 134.

A third radial distance r3 is indicated. At this radial distance, part of the flywheel body 124 is located. The third radial distance r3 is greater than the second radial distance r2. In particular, the flywheel comprises an upper recess 136 and a further optional lower recess 138. As an option, the rotor 132 and at least part of the stator 134, in particular the stator windings, are positioned inside the upper recess 136 of the flywheel.

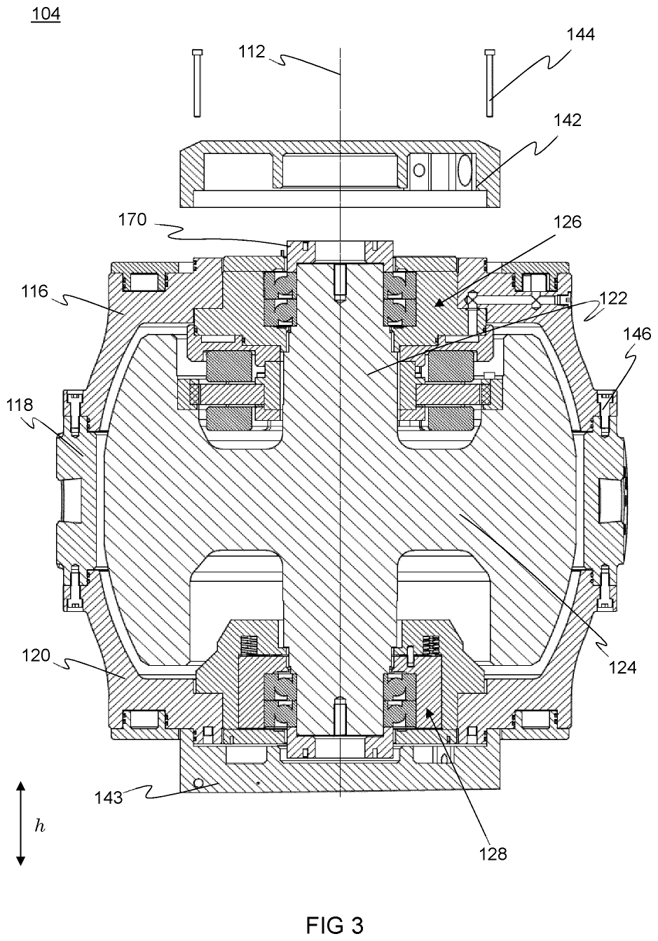

As shown for example in FIG. 2, the flywheel body 124 may be connected to the shaft at or approximately near the middle of the shaft. As shown for example in FIG. 3, the flywheel body 124 may radially extend from the shaft at or approximately near the middle of the shaft.

The rotor 132 and the stator 134 are in the embodiment of FIG. 2 positioned between the first bearing pack 126 and the second bearing pack 128. In particular, the rotor 132 and the stator 134 are positioned in an upper halve of the housing, at or near the upper segment 116.

Between the stator 134 and the shaft 122, an annular space 140 is provided, allowing the shaft 122 to rotate relative to the stator 134. The annular space 140 may further allow the stator 134, or at least part thereof, to be positioned surrounding the shaft 122.

FIG. 3 depicts the gyroscope 104 in a partially exploded section view, for example during a method of servicing or maintaining the gyroscope 104. In particular, a top cap 142 is disconnected from the upper segment 116 of the housing. The top cap 142 was for example connected to the upper segment 116 by means of screws 144. The top cap 142 may be used for restricting access to a shaft end 170 and/or the first bearing pack 126.

The shaft end 170 may be a removable shaft end which may be releasably connected to the shaft 122. A removable shaft end may be connected on both ends of the shaft 122, and may be used for example for preloading the shaft 122 and the bearings. A bottom cap 143 may be used for covering the opposite end of the shaft 122 near the second bearing pack 128.

A height of the gyroscope 104 may be determined by a height of the gyroscope 104 between the top cap 142 and the bottom cap 143, in particular because the motor is positioned between the top cap 142 and the bottom cap 143. The height direction is in FIG. 3 indicated with double arrow h. The majority of the height is determined by the height of the flywheel, in particular by a height of the shaft 122.

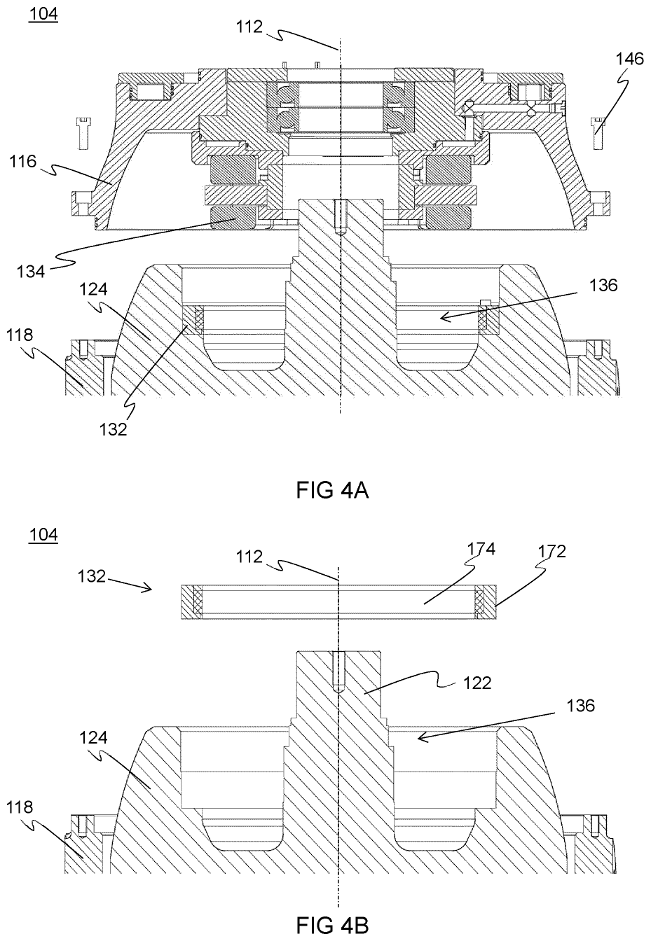

FIG. 4A depicts the gyroscope 104 in another partially exploded section view, for example during a method of servicing or maintaining the gyroscope 104. In particular, the upper segment 116 of the housing has been disconnected from the central segment 118, in this example by disconnecting screws 146.

The disconnection the upper segment 116 exposes the flywheel and the motor, in particular the rotor 132 and the stator 134.

FIG. 4B shows part of the gyroscope 104 in yet another exploded view. In particular, FIG. 4B shows the rotor 132 disconnected from the flywheel body 124. The rotor 132 may comprise a rotor carrier 172 carrying a plurality of magnets 174.

The rotor 132 may have been connected in the first recess 136 of the flywheel. The rotor 132 may be clamped into the first recess 136 against the flywheel body 124. Alternatively, or additionally, one or more of a glue and other connection means such as screws or clamps may be used for fixing an axial position of the rotor 132 relative to the flywheel.

FIG. 5A shows another exploded view of part of the gyroscope 104, in particular shown in the stator 134 of the motor disconnected from the upper segment 116 of the housing. The stator 134 may be releasably connected to the first bearing pack 126 by means of screws 148. Alternatively, a stator may be releasably connected directly to the upper segment 116. For disconnecting the stator 134, the stator may thus be disconnected from the first bearing pack 126, for example after the upper segment 116 has been disconnected from the rest of the housing to expose the stator 134.

As shown in FIG. 5A, for releasing the stator 134 from the upper segment 116, the stator is moved in an opposite direction as the direction wherein the upper segment 116 has been moved relative to the central segment 118 when disconnecting the upper segment 116 from the central segment 118. As such, when disassembling the gyroscope 104, first the upper segment 116 may have to be disconnected from the rest the housing before the stator 134 can be disconnected from the upper segment 116.

The stator 134 comprises a plurality of windings 158 wound around a core 160. The windings 158 may be connected to a stator support 162. Via the stator support 162, the stator 134 may be connected to the housing. The connection the housing may be directly to the upper segment 116, or the connection between the housing and the stator support 162 may be via the first bearing pack 126.

As for example shown in FIG. 5A, part of the stator support 162 may at least partially circumferentially surround the windings 158. In particular, said part of the stator support 162 may be formed as a protrusion 163 protruding away from the stator support 162, in particular in use in a direction away from the upper segment of the housing. The protrusion 163 may for example be generally ring-shaped.

FIG. 5B depicts in an exploded view part of the gyroscope 104. In particular, the first bearing pack 126 is shown disconnected from the upper segment 116. The first bearing pack 126 was releasably connected to the upper segment 116 by means of screws 150. Since the first bearing pack 126 is arranged to be connected to the upper segment 116, replacement of the first bearing pack does not require removal of the flywheel from the housing. This in turn may allow or make more convenient the replacement or maintenance of a bearing on-board of a vessel.

The first bearing pack 126 is shown in FIG. 5B comprising two ball bearings 152 or a double ball bearing, which may be angular contact bearings. The bearings 152 are sandwiched between a bearing carrier 154 and a locking ring 156. The bearing carrier may be embodied as a bushing with one or more flanges. In assembled form, an annular space may be present between the shaft and the bearing carrier for allowing rotation of the shaft relative to the bearing carrier. The locking ring 156 may for example be connected to the bearing carrier 154 by means of one or more screws, bolts, a threaded connection, a glued or welded connection, a clamped connection, any other connection or any combination thereof.

Any ball bearing may comprise an inner ring and an outer ring. In particular, an inner ring of any ball bearing may surround the shaft.

In general, one or more aspects disclosed in conjunction with the first bearing pack 126 and the upper segment 116 may be readily applicable to the second bearing pack 128 and the lower segment 120.

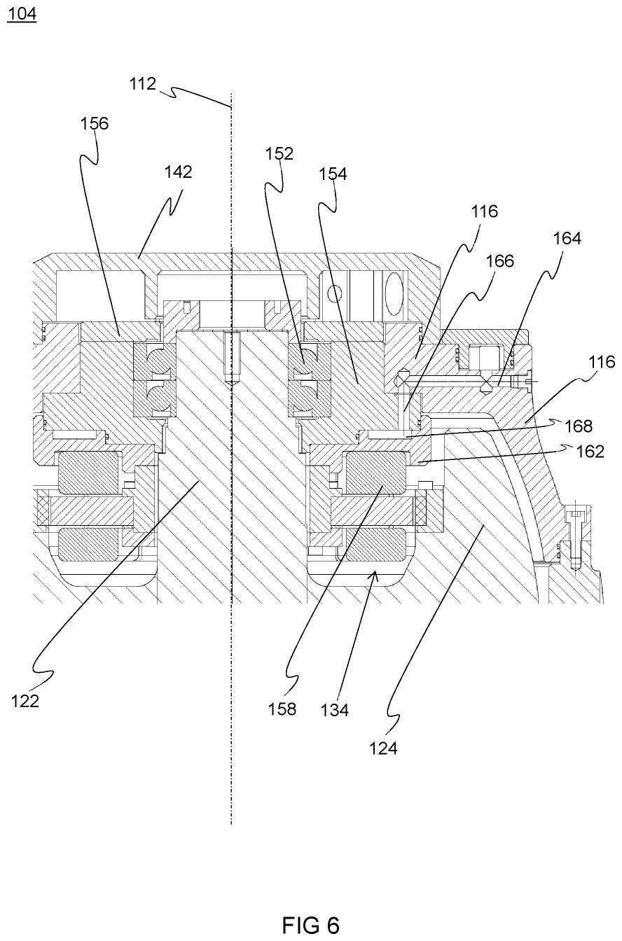

FIG. 6 shows in a section view a detail of the gyroscope 104, depicting an optional cooling system. The cooling system is arranged for, cooling the motor, in particular the stator 134, and more in particular the windings 158. The windings 158 may be surrounded or encapsulated in resin.

The gyroscope 104 of FIG. 6 comprises a cooling fluid distribution network for circulating cooling fluid through the gyroscope 104, in particular passed the stator 134 for extracting thermal energy from the stator 134. The cooling fluid distribution network comprises a housing conduit 164 through the housing, in particular through the upper segment 116.

Provided in fluid communication with the housing conduit 164 as part of the cooling fluid communication network is a bearing pack conduit 166 through the first bearing pack, in particular through the bearing carrier 154.

An as option, a passage 168 present between the stator and the first bearing pack, in particular between the stator support 162 and the bearing carrier 154. The passage 168 is part of the cooling fluid distribution network and is in fluid communication with the bearing pack conduit 166. The passage 168 may as a particular option be formed by a groove in the stator support 162. At least part of the stator support facing the passage 168 may include one or more surface features, such as grooves, intended to increase the surface area of the part of the stator support facing the passage 168. As such, heat transfer from the stator support to fluid passing through the passage 168 may be increased.

The cooling distribution network may as further options also comprise conduits through other components, such as the second bearing pack and the lower segment, for example for cooling the second bearing pack.

It will be understood that for clarity and conciseness of the figures, which show many different components, not all components are provided with a reference numeral.

Whenever screws are shown as an example for connecting two or more parts, it will be appreciated that any number of screws may be used. It will also be understood that instead or in additional to screws, any other releasable connection may be used. A non-exhaustive list of examples of releasable connections is: one or more bolts and nuts, a threaded connection, a clamping or clamped connection, a friction connection.

Two components being releasably connected implies that the connection between the two components may be undone, preferably without breaking, plastically deforming, or otherwise damaging one or both the components.

In the description above, it will be understood that when an element is referred to as being connect to another element, the element is either directly connected to the other element, or intervening elements may also be present. Also, it will be understood that the values given in the description above, are given by way of example and that other values may be possible and/or may be strived for.

It is to be noted that the figures are only schematic representations of embodiments that are given by way of non-limiting examples. For the purpose of clarity and a concise description, features are described herein as part of the same or separate embodiments, however, it will be appreciated that the scope of the disclosure may include embodiments having combinations of all or some of the features described.

The word ‘comprising’ does not exclude the presence of other features or steps. Furthermore, the words ‘a’ and ‘an’ shall not be construed as limited to ‘only one’, but instead are used to mean ‘at least one’, and do not exclude a plurality.

1. Gyroscope for an anti-roll stabilizer for a seacraft, comprising:
a housing, arranged to be mounted on a suspension which allows the housing to be oscillated around a first rotation axis;
a flywheel, positioned inside the housing, comprising a flywheel body connected to a shaft arranged to rotate around a second rotation axis, substantially transverse to the first axis, the shaft of the flywheel having a first end and a second end;
a first bearing pack rotationally connecting the first end of the shaft to the housing;
a second bearing pack rotationally connecting the second end of the shaft to the housing;
an electric motor arranged to rotate the flywheel around the second rotation axis, comprising a rotor and a stator;
wherein:
the stator of the electric motor is connected to the housing and the rotor of the electric motor is connected of the flywheel; and
the rotor is located radially at a greater distance from the second rotation axis than the stator.

2. Gyroscope according to claim 1, wherein the first bearing pack comprises an inner ring surrounding the shaft and an outer ring connected to the housing, and the second bearing pack comprises an inner ring surrounding the shaft and an outer ring connected to the housing.

3. Gyroscope according to claim 1, wherein the electric motor is positioned between the first bearing pack and the second bearing pack.

4. Gyroscope according to claim 1, wherein at least part of the flywheel is located radially at a second greater distance from the second rotation axis than the rotor.

5. Gyroscope according to claim 1, wherein the stator is located radially at a second greater distance from the second rotation axis than the shaft.

6. Gyroscope according to claim 5, wherein an annular space is provided between the shaft of the flywheel and the stator.

7. Gyroscope according to claim 1, wherein the flywheel body has a first recess disposed around the second rotation axis arranged to accommodate the stator and the rotor.

8. (canceled)

9. Gyroscope according to claim 1, wherein the shaft and the flywheel body are formed by a single integrally formed component.

10. Gyroscope according to claim 1, wherein the shaft and the flywheel body are formed as separate components.

11. Gyroscope according to claim 1, wherein the housing comprises an upper segment, a central segment and a lower segment which are arranged such that the upper segment can be releasably connected to an upper part of the central segment and the lower segment can be releasably connected to a lower part of the central segment.

12. (canceled)

13. Gyroscope according to claim 11, wherein the housing comprises an opening for a power cable of the electric motor arranged to be sealed air tight with resin when the power cable is present in the opening.

14. Gyroscope according to claim 13, wherein the power cable is releasably connected to the electric motor.

15. Gyroscope according to claim 11, wherein the shaft extends through the central segment of the housing.

16. Gyroscope according to claim 1, further comprising a cooling fluid distribution network for circulating cooling fluid through the gyroscope, comprising a housing conduit for distributing fluid through the housing.

17. Gyroscope according to claim 16, wherein the cooling fluid distribution network further comprises a bearing pack conduit through the first bearing pack, which bearing pack conduit is in fluid communication with the housing conduit.

18. Gyroscope according to claim 16, wherein the cooling fluid distribution network further comprises a passage between the first bearing pack and the stator, which passage is in fluid communication with the housing conduit.

19. Anti-roll stabilizer for a vessel, comprising:
a gyroscope according to claim 1;
a frame arranged to be mounted to a vessel; and
a suspension allowing the housing of the gyroscope to be oscillated around a first rotation axis relative to the frame.

20. Vessel provided with the anti-roll stabilizer according to claim 19.

21. Method of servicing or maintaining a gyroscope of an anti-roll stabilizer onboard of a vessel, comprising the steps of:
disconnecting an upper segment from a housing of the gyroscope for exposing a flywheel and an electric motor;
at least one of:
disconnecting a rotor of the electric motor from the flywheel; and
disconnecting a stator of the electric motor from the upper segment of the housing;
at least one of:
reconnecting a rotor of the electric motor to the flywheel; and
reconnecting a stator of the electric motor to the upper segment of the housing;
reconnecting the upper segment to the housing of the gyroscope; and
removing air from an interior of the housing after the upper segment has been reconnected to the housing.

22. Method according to claim 21, comprising the step of disconnecting the stator of the electric motor from the upper segment of the housing.

23. (canceled)
